(19) United States
(12) Patent Application Publication
(10) Pub. No.: US 2017/0168873 A1
(43) Pub. Date: Jun. 15, 2017

(54) METHOD, DEVICE, AND SYSTEM FOR DECIDING ON A DISTRIBUTION PATH OF A TASK

(71) Applicant: Hybridserver Tec IP GmbH, Hergiswil (CH)

(72) Inventors: Hendrik Dürkop, Hamburg (DE); Tobias Zielinski, Hamburg (DE); Halis Aslan, Hamburg (DE); Farbod Saremi, Hamburg (DE)

(21) Appl. No.: 15/444,965

(22) Filed: Feb. 28, 2017

Related U.S. Application Data
(63) Continuation of application No. PCT/EP2015/070382, filed on Sep. 7, 2015.

(30) Foreign Application Priority Data
Sep. 16, 2014 (EP) 14185007.3

(51) Int. Cl. G06F 9/50; G06F 9/48

(52) U.S. Cl. CPC G06F 9/5055; G06F 9/4887

(57) ABSTRACT

A method for deciding on a distribution path of a task includes the following steps: identifying one or more processing elements from the plurality of processing elements that are capable of processing the task, identifying one or more paths for communicating with the one or more identified processing elements, predicting a cycle length for one or more of the identified processing elements and the identified paths, selecting a preferred processing element from the identified processing elements, and selecting a preferred path from the identified paths. The method may be executed by a device or a system.

### CROSS REFERENCE TO RELATED APPLICATION

This application is a continuation of International Application No. PCT/EP2015/070382 having an international filing date of Sep. 7, 2015 and a priority date of Sep. 16, 2014, the entirety of which incorporated by reference in its entirety.

### BACKGROUND

1. Field of the Invention

The present invention relates to a method for deciding on a distribution path of a task in a device that comprises one or more busses and a plurality of processing elements. Further, the present invention relates to a device and a system that are configured to decide on a distribution path.

2. Description of Related Art

Nowadays, large data amounts become available through the rapidly developing communication and computing techniques. Whereas highly specialized processing elements have been developed that are configured to efficiently execute different kinds of processing tasks, many resources are wasted because the tasks are inefficiently transported from a control element to a suitable processing element.

Some of known hardware/software solutions might pro-vide improvements into one direction or another. However, they still do not improve any or at least most of the above-listed criteria. Therefore, there is still a need for an improved hardware or software solution for optimizing the processing of tasks on a number of processing elements

### SUMMARY

It is, therefore, an object of the present invention to provide a method, a device and a server system that overcome some of the above-mentioned problems of the prior art.

Particularly, the advantages of the present invention are achieved by appended independent claims. Further aspects, embodiments, and features of the present invention are specified in the appended dependent claims and the description and also make a contribution to achieving said advantages.

According to an embodiment of the present invention, the method for deciding on a distribution path of a task comprises the steps:
identifying one or more processing elements from the plurality of processing elements that are capable of processing the task,
identifying one or more paths for communicating with the one or more identified processing elements,
predicting a cycle length for one or more of the identified processing elements and the identified paths,
selecting a preferred processing element from the identified processing elements and selecting a preferred path from the identified paths.

The present invention is based on the idea that based on a cycle length prediction that particular path and processing element that lead to the fastest processing of the task are chosen. The method of the present invention thus avoids wasting of resources that are caused by using unnecessary long paths for communicating with a processing element or by using a processing element that is not ideally suited for processing a given task.

The present invention can be implemented in particular with bus systems where for at least one processing element at least two paths for communicating with this processing element are available. In particular, the invention is advantageous if the transfer times for the at least two paths are different.

Some elements of the bus can act both as control elements and as processing elements. For example, a first control element can send a task to a second control element, which then acts as processing element.

According to an embodiment of the present invention, access to the one or more busses is managed using a time division multiple access (TDMA) scheme. In a simple TDMA scheme, the active element of the bus is changed in fixed time increments. In this way, it is determined in advance, when which element will be allowed to access the bus. In the context of the present invention, this has the advantage that precise predictions about future availability of the one or more busses can be made.

According to a further embodiment of the present invention, access to the one or more busses is managed using a token passing scheme. In particular, an access token can be passed from a first element of the bus to the next element, when the first element is finished accessing the bus. Token passing schemes can be more efficient than simple TDMA schemes because idle time slots are avoided. On the other hand, the prediction of future bus availability can be more complicated. To this end, the control element can keep a table of current and future tasks to be executed on the bus. This allows an accurate prediction of future bus availability and choosing processing elements and transfer paths such that the one or more busses are used most efficiently.

According to a further embodiment of the present invention, the one or more busses are set up as token rings, i.e. the neighbors of an element are the physical neighbors of this element.

The present invention can also be used with other protocols for controlling access to the one or more busses. These can include static and dynamic access control schemes, e.g. scheduling methods and random access methods.

The present invention can be used with different kinds of topologies, in particular linear busses, ring busses, and branch topologies, star networks and tree topologies. In some embodiments, the method of the present invention can even be used in conjunction with fully connected meshes.

A task can comprise one or more instructions and data.

Identifying one or more processing elements that are capable of processing the task can be performed for example by using a lookup table which for each processing element provides the information, which processing capabilities it has. For example, for a given processing element that comprises a graphical processing unit (GPU) the table could comprise the information that this processing element can process certain tasks relating to certain graphical processing instructions.

Identifying one or more paths for communicating with the one or more identified processing elements can be implemented by looking up in a table through which busses a given processing element is connected with the control element that is requesting processing of this task. Even if there is only one bus available to communicate with the given processing element, there might be two directions available through which the control element can communicate with this processing element. In this case, there might be e.g. two paths available for communicating with the processing element in clockwise or counter-clockwise direction on a ring bus. Furthermore, a bus might comprise branches, which also result in a plurality of paths that are available for a communication with a given processing element.

Predicting a cycle length for one or more of the identified processing elements and the identified paths may comprise using two lookup tables: a first lookup table which stores path lengths for different paths between control elements and processing elements and a second lookup table which stores information about the expected processing time for different tasks and different processing elements. For example, the second lookup table could comprise the information that a certain graphical processing instruction requires 10 clock cycles to process on a first processing element, but only eight clock cycles the process on a second processing element.

In other embodiments of the invention, there is only one lookup table, which comprises information about the expected processing times for different kinds of tasks on different processing elements. For example, such a table can comprise expected processing times for a certain instruction on a certain processing element, with further information about how the processing time varies depending on the amount of input data for this instruction.

In other words, the cycle length can be predicted based on one or more of the following information: knowledge, how the bus is structured; in which state or position the bus and or the processing elements are at the moment; information about which tasks with which amount of data need to be processed; information, whether a given task comprises more datasets than can be stored in one vector, such that the task should ideally be distributed across the available processing elements, i.e. SIMD (single instruction, multiple data) across individual processing elements and processing steps.

In some cases, the predictions may be based on exact calculations. In other cases, the predictions may be based on heuristics and only be a rough estimation of the true path time or processing time.

According to an embodiment of the present invention, the cycle length for an identified processing element and an identified path is predicted based on:
a predicted forward transfer time for transferring an instruction and input data to the processing element on the identified path,
a predicted return transfer time for transferring output data from the processing element on the identified path, and/or
a predicted processing time for processing the task on the identified processing element.

The predicted forward transfer time and the predicted return transfer time may comprise the time for the entire input data to arrive at the processing element.

According to an embodiment of the present invention, the predicted cycle length is the sum of the predicted forward transfer time, the predicted return transfer time and the predicted processing time.

This embodiment has the advantage that the predicted cycle length is particularly quick and efficient to compute. In some embodiments, the sum of the predicted forward transfer time, the predicted return transfer time and the predicted processing time may be a weighted sum. This can be particularly useful if only some of the predicted times can be exactly calculated. In this case, a higher weighting may be given to the time which is exactly calculated.

According to an embodiment of the present invention, predicting the cycle length is based on at least one of
the current availability and/or utilization of the one or more busses, and
the current availability and/or utilization of the one or more identified processing elements.

Considering the current availability and/or utilization of the busses and the processing elements allows for an even more precise prediction of path time and processing time.

According to an embodiment of the present invention, the method further comprises:
beginning processing of the task on the selected processing element,
updating the predicted cycle length of the task to obtain a predicted remaining cycle length of the task,
canceling the processing of the task on the selected processing element if it is determined that the predicted remaining cycle length is higher than a predicted cycle length for processing the task in a different processing element, and
assigning the task to said different processing element.

Updating the predicted cycle length of the task to obtain a predicted remaining cycle length of the task has the advantage that further information, that becomes available only after the processing of the task has started, can be considered. For example, in cases where information becomes available that a processing element that has already started processing certain tasks is slowed down and expectedly, it may be decided to cancel processing of the task on this processing element and defer the task to a different processing element.

This embodiment of the invention has the further advantage that the processing of the task on a given processing element can be canceled if the processing takes much longer than predicted, which may be an indication that the processing on this processing element has been falsely predicted.

In other embodiments of the invention, the processing of a task on a selected processing element can be canceled if the control element determines that this processing element is needed to process a task with higher priority. This can be particularly relevant in a case of predicted likely future tasks.

In a further preferred embodiment of the invention, the information that the processing of tasks on a given processing element has taken a longer time than predicted is stored in a table and considered when predicting processing elements for similar tasks. In particular, if the processing of a certain task has failed on a given processing element, this information can be stored in a table. In extreme cases, where the processing of a certain kind of the task has repeatedly failed on a given processing element it may be decided that similar tasks should not be processed on this processing element, even if the processing element indicates that it is available.

According to an embodiment of the present invention, the method further comprises:
determining a threshold time for the processing of the task,
beginning processing of the task on the selected processing element,
checking whether the actual processing time for the task is higher than the threshold time,
canceling the processing of the task if the actual processing time is higher than the threshold time,
assigning the task to a different processing element.

This embodiment provides a simple way of deciding when execution of a certain task should be canceled because it is taking significantly longer than expected, which is likely due to a processing failure.

According to a further embodiment of the invention, there is provided a device, comprising
one or more busses,
one or more control elements, and
a plurality of processing elements, wherein at least one of the control elements is configured to decide on a distribution path for a task based on:
identifying one or more processing elements from the plurality of processing elements that are capable of processing the task,
identifying one or more paths for communicating with the one or more identified processing elements,
predicting a cycle length for one or more of the identified processing elements and the identified paths,
selecting a preferred processing element from the identified processing elements and selecting a preferred path from the identified paths.

According to an embodiment of the present invention, at least one of the control elements is configured to predict the cycle length based on
a predicted forward transfer time for transferring an instruction and input data to the processing element,
a predicted return transfer time for transferring output data from the processing element, and/or
a predicted processing time for processing the task in a processing element.

According to an embodiment of the present invention, at least one of the control elements is configured to carry out the steps:
beginning execution of the task on the selected processing element,
updating the predicted cycle length of the task to obtain a predicted remaining cycle length of the task,
canceling the processing of the task on the selected processing element if it is determined that the predicted remaining cycle length is higher than a predicted cycle length for processing the task in a different processing element, and
reassigning the task to said different processing element.

According to an embodiment of the present invention, the device further comprises a busy table comprising information about the current availability and/or utilization of the plurality of processing elements, wherein the control element is configured to regularly update the information in the busy table.

According to an embodiment of the present invention, the one or more busses comprise one or more rings.

According to a further embodiment of the present invention, the one or more busses comprise a first set of busses for transporting instructions and a second set of busses for transporting data. This has the advantage that the first of busses can be optimized for low-latency transmission of instructions and the second set of busses can be optimized for high bandwidth transmission of potentially large amounts of data. In particular, the first and second set of busses can operate at different frequencies, e.g. the first set of busses can operate at a higher frequency whereas the second set of busses operates at a lower frequency, but provides a higher transmission capacity per cycle.

According to a further embodiment of the present invention, the one or more busses comprise two rings that are unidirectional and oriented in opposite directions.

In this way, the present invention can be executed in a particularly efficient manner because a lot of data transport time can be saved if the more suitable of the two differently oriented ring busses is chosen.

According to an embodiment of the present invention, the one or more busses comprise an Element Interconnect Bus.

According to a further embodiment of the present invention, at least one of the plurality of processing elements is connected to the one or more busses and additionally comprises a direct connection to the primary processing element.

According to an embodiment of the present invention, the device further comprises a prediction module that is configured to predict future tasks based on previously processed tasks.

Predicting future tasks has the advantage that data required for a future task can be preloaded already before the task is actually executed. For example, if it is detected that previous tasks involved loading data1.jpg, data2.jpg, and data3.jpg, the prediction module could predict that a future task likely will involve loading a possibly existent data4.jpg and thus preload data4.jpg already before the corresponding task is started. In a preferred embodiment, such preloading of data is performed only if the system is under low load, for example, if the current load of the control element is lower than a predetermined threshold value.

According to a further embodiment of the present invention, the device is configured to cancel one or more predicted future tasks in favor of executing current tasks if one or more new tasks arrive after beginning execution of one or more predicted future task. For example, it may turn out that the prediction was not accurate and the new tasks should be executed instead of the predicted future tasks.

According to a further embodiment of the present invention, there is provided a server system, comprising a device according to one of the above-described embodiments.

In this way, also a server system is preferably configured such that it provides all of the positive effects listed in the present application. Additionally, introduction and/or use of existing data center infrastructures/components/modules/elements is enabled at the same time.

According to an embodiment of the present invention, there is provided an ASIC or FPGA which is configured to carry out the method as outlined above and explained in more detail below.

According to a further aspect of the present invention, the one or more busses, the one or more control elements, and at least some of the plurality of processing elements are located inside the same chip housing. This has the advantage that a particularly high bandwidth can be achieved for communicating with the components that are located within the same housing. Furthermore, this set-up yields cost savings in mass production.

According to a further embodiment of the present invention, there is provided a computer-readable medium comprising a program code, which, when executed by a computing device, causes the computing device to carry out the method as outlined above and explained in more detail below.

Further objects, features, and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 shows a schematic representation of a bus system with ring structure, in particular, forming part of a device;

FIG. 2 shows a schematic representation of a further bus system with ring structure;

FIG. 3 shows a schematic representation of a bus system with ring structure, where each of the rings is not connected with each of the elements;

FIG. 4 shows a schematic representation of a further bus system, with indicated pointers to current and future active elements;

FIG. 5 shows a schematic representation of a further bus system;

FIG. 6 shows a schematic representation of a bus system with TDMA structure that operates bi-directional;

FIG. 7 shows a schematic representation of a bus system with TDMA structure with branches and that operates bi-directional;

FIG. 7a shows a schematic representation of the bus system of FIG. 7, with a global token in a primary branch;

FIG. 7b shows a schematic representation of the bus system of FIG. 7, with a global token in a secondary branch and optionally a local token in a different secondary branch; and

FIG. 8 shows a schematic representation of a bus system with TDMA structure that operates bi-directional in which not all but some elements share the same busses.

### DETAILED DESCRIPTION

FIG. 1 shows a schematic representation of a bus system 110 with a ring topology. In particular, the bus system 110 forms part of a device D. The bus system 110 comprises a first ring bus 112 which is configured to transport instructions and data in a counter-clockwise direction and a second ring bus 114 which is configured to transport instructions and data in a clockwise direction. In other words, the first and the second ring bus 112, 114 are configured to transport instructions and data in opposite directions. Attached to the busses 112 and 114 is a processing core 120, which acts as a control element. Furthermore, there is a plurality of elements of various functionality 122-134 connected to the busses 112, 114. The elements 122-134 comprise a random access memory (RAM) 122, a flash memory 124, a mass storage controller 126, a network interface controller 128, an I2C bus 130, a Peripheral Component Interconnect Express bus (PCIe) 132 and further miscellaneous devices 134.

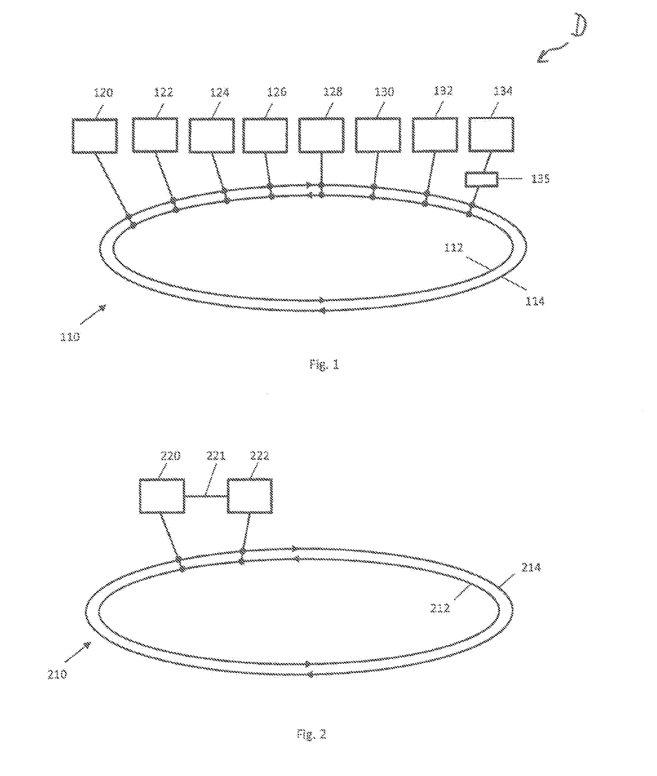

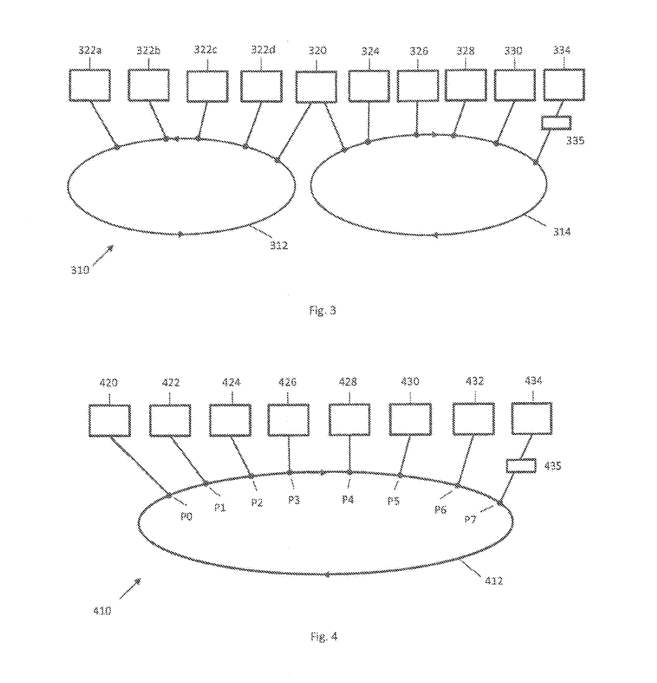

The ring busses 112, 114 are set up as direct connections between the connected elements 120-134, operated in a time-shifted manner. For the system of FIG. 1, the elements 120-134 are connected to both busses 112, 114. There are, however, no direct connections between the busses 112, 114. Similarly, the systems shown in FIG. 2 and FIG. 5 do not comprise any direct connections between the busses. In other embodiments of the invention, the busses can comprise direct connections.

Successively, the connected elements 120-134 are allowed to write, i.e., the active status is passed from one element to the next and read or write operations can only be performed by the element that is active at a given point in time. In some embodiments, more than one task can be transported in one clock cycle. Also, more than one dataset can be attached to one task (SIMD). Depending on the number of bus rings, the number of connected elements 120-134 and the starting position and direction of the pointer, it can happen that more than one ring addresses the same element at one point in time. For this case, a FIFO buffer can be provided that absorbs the additional instructions and data. In FIG. 1, the FIFO buffer 135 is shown only for the other miscellaneous element 134, but in a similar way, FIFO buffers can be provided for all processing elements 120-134.

FIG. 2 shows a schematic representation of a non-exclusive bus system 210 comprising ring busses 212, 214 with a processing core 220 and a RAM 222 connected to them. Furthermore, the processing core 220 and the RAM 222 are connected through a direct connection 221. Further elements can be connected to the ring busses 212, 214, but are not shown in FIG. 2. Similar to the bus system 110 in FIG. 1, the bus system in FIG. 2 comprises a first ring bus 212 which is configured to transport instructions and data in a counter-clockwise direction and a second ring bus 214 which is configured to transport instructions and data in a clockwise direction.

It should be noted that in other embodiments of the invention, the ring busses 112, 114; 212, 214 shown in FIGS. 1 and 2 can also be implemented with access protocols where the active time slot is passed from a first element to the next element when the first element is finished with accessing the bus. This can be implemented e.g. as a token ring access scheme, where an element 120-134, 220, 222 passes the token to the next element 120-134, 220, 222 when it has finished accessing the bus.

FIG. 3 shows a schematic representation of a bus system 310 comprising two rings 312, 314, where neither the first ring 312 nor the second ring 314 is connected with all of the processing elements 320 to 334. Similar to the bus system 110 in FIG. 1, the bus system in FIG. 3 comprises a first ring bus 312 which is configured to transport instructions and data in a counter-clockwise direction and a second ring bus 314 which is configured to transport instructions and data in a clockwise direction. In the embodiment of FIG. 3, only the processing core 320 is connected to both the first ring 312 and the second ring 314. In other embodiments of the invention, the one or more elements that are connected to both the first ring 312 and the second ring 314 can be a RAM or a controller that connects to elements outside the chip. Other devices 334, which may be located outside the chip, can be connected to the two rings 312, 314 via a FIFO buffer 335.

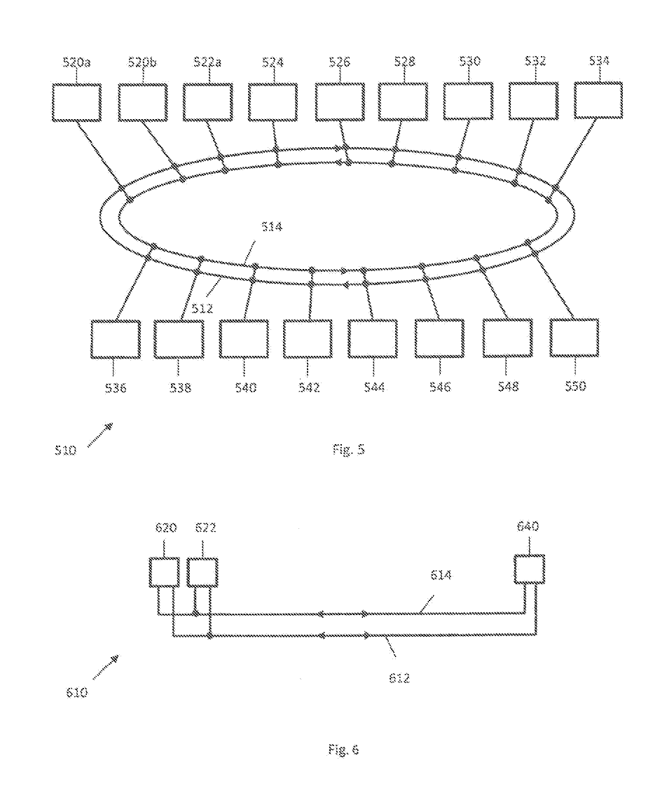

FIG. 4 shows a schematic representation of a bus system 410 having a ring bus 412, wherein the pointer to the current active element is indicated as P0 and pointers to the next active elements are indicated as P1 to P7. In this embodiment, a processing core 420, which acts as a control element, a RAM 422, a Flash 424, a storage 426, a network interface controller (NIC) 428, an I2C bus 430, a PCIe 432 and other elements 434 are connected to the ring bus 412, wherein the other elements 434 are connected to the ring bus 412 via a FIFO buffer 435. The ring bus 412 is configured to transport data in a clock-wise direction and also the pointer passes through the ring in a clockwise direction. In the shown example, the elements 420-434 are separated by the distance of one clock cycle. Other embodiments may provide that the pointer position passes through the ring with different time increments which may or may not be equal in length. The forwarding of the pointer can be decided e.g. based on static priorities that are assigned to the different elements.

FIG. 5 shows a schematic representation of a further bus system 510 in accordance with an embodiment of the present invention.

One mode of operation according to an embodiment of the invention shall be illustrated with the following example: Assuming that primary processing element 520a acts as a control element and sends a task that can be processed on one of the secondary processing elements 536-550: According to a prior art processing method, based on a previous successful result stored in one of the lookup tables, the task would be sent to secondary processing element 540 using first ring 512, which requires 14 clock cycles. After processing in the secondary processing element 540, which requires 4 clock cycles, the output data would be returned to primary processing element 520a on the first ring 512, which takes another 3 clock cycles. It takes a further 13 clock cycles before the active slot is returned to the primary processing element 520a. This yields a total cycle time of 14+4+13+3=34 clock cycles. According to the present invention, ideally it would be determined that the predicted cycle time is only 3+4+0+3=10 clock cycles if the task is sent to the secondary processing element 540 via the second ring 514, and returned to the primary processing element 520a via the first ring 512 without any bus waiting time because by set-up the ring 514 may have an exactly matching offset to ring 512. In this example, the method according to the present invention leads to a reduction of the cycle time to less than a third of the cycle time according to the prior art approach.

The n connected elements correspond to n different pointer positions.

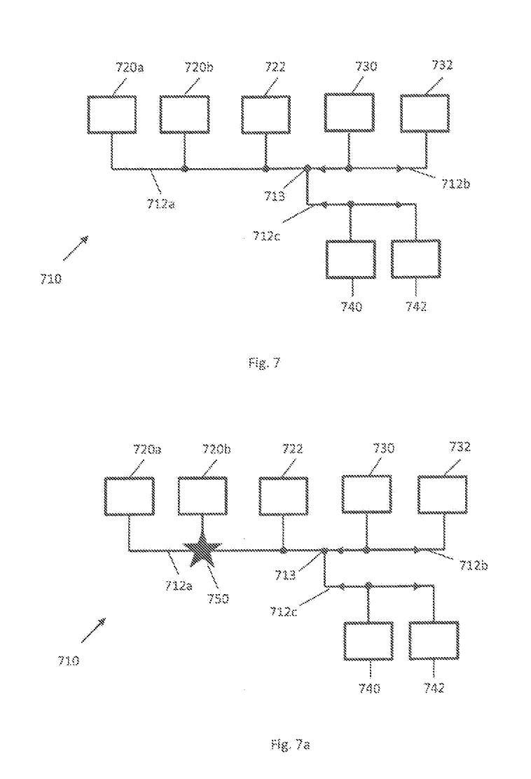

FIG. 6 shows a schematic representation of a further bus system 610 in accordance with an aspect of the present invention. The bus system 610 is set-up with two bi-directional busses 612, 614 with a linear topology and a time division multiple access scheme. FIG. 6 shows three elements 620, 622, 640 that are connected to both linear busses 612, 614. In general, there can be a number of n such elements connected to both busses. Several of these elements 620, 622, 640 can act as control elements, with the other elements acting as processing elements, controlled by the control elements. In addition to the control and processing elements other elements e.g. a RAM controller could be connected to the busses 612, 614, too.

Alternatively, the bus system 610 can also be set up using a token passing scheme where the token is passed from one station to the next, wherein the “next” station is defined based on the addresses of the bus interfaces of the elements connected to the bus.

In a further embodiment of the invention, the pointer can be pushed or pulled by a connected control element to receive or send data to or from any other connected element.

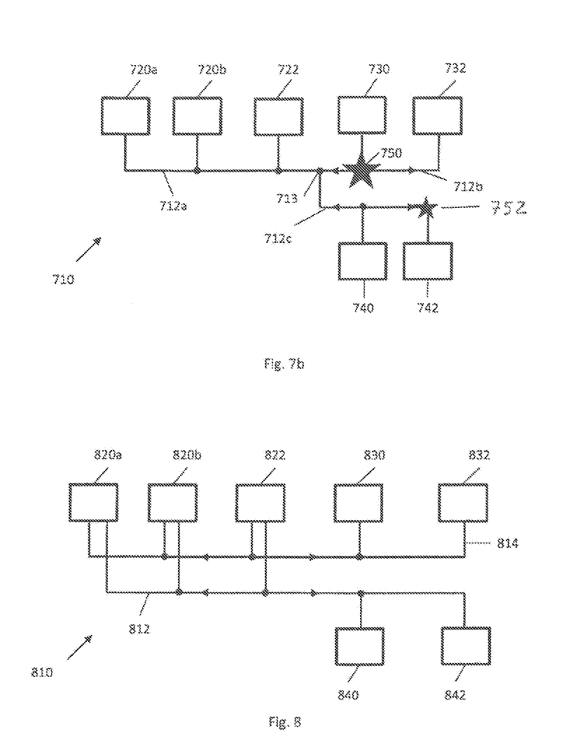

FIG. 7 shows a schematic representation of a non-exclusive bus system 710 that comprises three linear parts 712a, 712b, 712c, which are bi-directional busses and that are connected through a branch 713. Connected to the bus system 710 are: two control elements 720a, 720b and a RAM 722 that are connected to the first linear part 712a, two processing elements 730, 732 that are connected to the second linear part 712b and two processing elements 740, 742 that are connected to the third linear part 712c of the bus system 710. In addition to second and third linear part 712b, 712c shown in FIG. 7, there can be any number of additional linear parts which are also connected to the first linear part 712a. These additional linear parts can comprise the same number of connected elements.

For example, the RAM component 722 has a total of three physical neighbors: control element 720b, processing element 730 of the second part 712b and processing element 740 of the third part 712c. Therefore, access to this bus system 710 should be managed with a token passing scheme where the neighbor relations are defined based on the addresses of the connected elements. It should be noted that linear parts 712b and 712c can be active at the same time. Temporary or second-level tokens are used to assign the active slot within one linear part. Knowledge about the current state and the predicted future availability of the linear parts 712a, 712b and 712c can be used by the cycle prediction method and by the decision which processing elements the tasks are assigned to.

In an advantageous embodiment, to allow for the use of more than one token per bus 712a, 712b, 712c, there is a primary branch part and a plurality of secondary branch parts. This is illustrated in FIGS. 7a and 7b, where the first linear part 712a forms a primary branch and second and third linear part 712b, 712c form a secondary branch part.

To avoid conflicts, there can only be one global token 750 which always has traversing priorities. The global token 750 is indicated in FIGS. 7a and 7b as a big star, the local token 752 as a small star. If the global token 750 is present on the primary branch part, as shown in FIG. 7a, there cannot be any local tokens on any of the secondary branch parts. However, if the global token 750 is present on one of the secondary branch parts, as shown in FIG. 7b, it is possible to allow for local tokens 752 in all or some of the other secondary branch parts which cannot leave their individual secondary branch parts.

FIG. 8 shows a schematic representation of a non-exclusive bus system 810 comprising two bi-directional busses 812, 814. A first control element 820a, a second control element 820b and a RAM 822 are connected to both the first bus 812 and the second bus 814. A number of n processing elements 830, 832 are connected only to the second bus 814 and a number of n processing elements 840, 842 are connected only to the first bus 812. This set-up can be repeated n times such that there is a total of m*n processing elements connected to the bus system 810. The set-up shown in FIG. 8 has the advantage that for example, the communication between the control elements 820a, 820b and RAM 822 can occur both through the first bus 812 and the second bus 814. This enables a total bandwidth that is twice as high compared to the bandwidth for communicating with the processing elements 830, 832, 840, 842, which may be accessed less often than the RAM 822. In this way, the architecture is configured to the typical load scenarios. Another benefit is that communication with more than one synergistic processing elements (SPEs) can occur simultaneously.

Access to the busses 812, 814 can be implemented with a simple time division multiple access scheme. Alternatively, for example, a token passing scheme or a combination of the two can be used.

With regard to the embodiments explained above, it has to be noted that said embodiments may be combined with each other. Furthermore, it is understood, that the bus systems shown in the drawings can comprise further elements and further busses that are not shown in the drawings. In particular, branches as shown in FIG. 7 could also connect ring busses with linear parts. Furthermore, different busses that are connected via a bridge or share at least one element could use different access schemes.

The bus systems 110, 210, 310, 410, 510, 610, 710, 810 in particular form part of a device D. The device comprises therefore one or more busses 112, 114, 212, 214, 312, 314, 412, 512, 514, 612, 614, 712a, 712b, 712c, 812, 814, one or more control elements 120, 220, 320, 420, 520a, 520b, 620, 720a, 720b and a plurality of processing elements 122-134, 222, 322-334, 422-434, 522-550, 620-640, 720a-742, 822-842. In this device D, at least one of the control elements 120, 220, 320, 420, 520a, 520b, 620, 720a, 720b is configured to decide on a distribution path for a task based on:
identifying one or more processing elements 122-134, 222, 322-334, 422-434, 522-550, 620-640, 720a-742, 822-842 from the plurality of processing elements that are capable of processing the task,
identifying one or more paths for communicating with the one or more identified processing elements 122-134, 222, 322-334, 422-434, 522-550, 620-640, 720a-742, 822-842,
predicting a cycle length for one or more of the identified processing elements 122-134, 222, 322-334, 422-434, 522-550, 620-640, 720a-742, 822-842 and the identified paths, selecting a preferred processing element 122-134, 222, 322-334, 422-434, 522-550, 620-640, 720a-742, 822-842 from the identified processing elements and selecting a preferred path from the identified paths.

Furthermore, there is a server system, comprising at least one device D being configured according to the aspects mentioned.

In an alternative embodiment, dedicated hardware implementations, such as application specific integrated circuits, programmable logic arrays, and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation, and change, without departing from the spirit of this invention, as defined in the following claims.

1. A method for deciding on a distribution path of a task in a device that comprises one or more busses and a plurality of processing elements, the method comprising the steps:
identifying one or more processing elements from the plurality of processing elements that are capable of processing the task;
identifying one or more paths for communicating with the one or more identified processing elements;
predicting a cycle length for one or more of the identified processing elements and the identified paths; and
selecting a preferred processing element from the identified processing elements and selecting a preferred path from the identified paths.

2. The method of claim 1, wherein the cycle length for an identified processing element and an identified path is predicted based on at least one of:
a predicted forward transfer time for transferring an instruction and input data to the identified processing element (on the identified path;
a predicted return transfer time for transferring output data from the identified processing element on the identified path; or
a predicted processing time for processing the task on the identified processing element.

3. The method of claim 2, wherein the predicted cycle length is the sum of the predicted forward transfer time, the predicted return transfer time and the predicted processing time.

4. The method of claim 1, wherein predicting the cycle length is based on at least one of:
the current availability or utilization of the one or more busses; and
the current availability or utilization of the one or more identified processing elements.

5. The method of claim 1, wherein the method further comprises:
beginning processing of the task on the selected processing element;
updating the predicted cycle length of the task to obtain a predicted remaining cycle length of the task;
cancelling the processing of the task on the selected processing element when it is determined that the predicted remaining cycle length is higher than a predicted cycle length for processing the task in a different processing element; and
assigning the task to said different processing element.

6. The method of claim 1, wherein the method further comprises:
determining a threshold time for the processing of the task;
beginning processing of the task on the selected processing element;
checking whether the actual processing time for the task is higher than the threshold time;
canceling the processing of the task if the actual processing time is higher than the threshold time; and
assigning the task to a different processing element.

7. A device, the device comprising:
one or more busses;
one or more control elements; and
a plurality of processing elements;
wherein at least one of the control elements (is configured to decide on a distribution path for a task executed by the device based on:
identifying one or more processing elements from the plurality of processing elements that are capable of processing the task,
identifying one or more paths for communicating with the one or more identified processing elements,
predicting a cycle length for one or more of the identified processing elements and the identified paths, and
selecting a preferred processing element from the identified processing elements and selecting a preferred path from the identified paths.

8. The device of claim 7, wherein at least one of the control elements is configured to predict the cycle length based on at least one of:
predicted forward transfer time for transferring an instruction and input data to the processing element;
a predicted return transfer time for transferring output data from the processing element; or
a predicted processing time for processing the task in a processing element.

9. The device of claim 7, wherein at least one of the control elements is configured to:
begin execution of the task on the selected processing element;
update the predicted cycle length of the task to obtain a predicted remaining cycle length of the task;
cancel the processing of the task on the selected processing element when it is determined that the predicted remaining cycle length is higher than a predicted cycle length for processing the task in a different processing element; and
reassign the task to said different processing element.

10. The device of claim 7, the device further comprising one or more busy tables comprising information about at least one of the capabilities or current availability or utilization of the plurality of processing elements, wherein at least one of the control elements is configured to regularly update the information in the one or more busy tables.

11. The device of claim 7, wherein the one or more busses comprise one or more rings.

12. The device of claim 7, wherein the one or more busses comprise a first set of busses for transporting instructions and a second set of busses for transporting data.

13. The device of claim 7, wherein the one or more busses comprise two rings that are unidirectional and oriented in opposite directions.

14. The device of claim 7, wherein the one or more busses (comprise an Element Interconnect Bus.

15. The device of claim 7, wherein at least one of the plurality of elements (is connected to the one or more busses and additionally comprises a direct connection to at least one other element.

16. The device claim 7, further comprising a prediction module that is configured to predict future tasks based on previously processed tasks.

17. The device of claim 16, wherein the device is configured to cancel one or more predicted future tasks in favor of executing current tasks if one or more new tasks arrive after beginning execution of one or more predicted future tasks.

18. The device of claim 7, wherein the one or more busses, the one or more control elements, and at least some of the plurality of processing elements are located inside a same chip housing.

19. The device of claim 7, wherein the device is part of a server system.
